(19) United States
(12) Patent Application Publication
(10) Pub. No.: US 2006/0257646 A1
(43) Pub. Date: Nov. 16, 2006

(54) Lap sealable films

(75) Inventors: Michael G. Fatica, North Kingstown, RI (US); Arron Carroll, West Warwick, RI (US)

Correspondence Address: MORRISON & FOERSTER LLP, 1650 TYSONS BOULEVARD, SUITE 300, MCLEAN, VA, 22102, US

(73) Assignee: TORAY PLASTICS (AMERICA), INC., N. Kingstown, RI (US)

(21) Appl. No.: 11/416,386

(22) Filed: May 3, 2006

Related U.S. Application Data
(60) Provisional application No. 60/678,345, filed on May 6, 2005.

(51) Int. Cl. B32B 27/20; B32B 27/36; B29C 47/06

(52) U.S. Cl. 428/323; 428/480; 428/336; 428/331; 264/173.16; 264/211

(57) ABSTRACT

A lap sealable film with superior film properties including a core layer of highly crystalline biaxially oriented polyester; first and second lap sealable non-crystalline or low-crystalline polyester layers each including substantially spherical particles and disposed onto opposite sides of the core layer. The first and second lap sealable polyester layers are adhered to the core layer.

### CROSS REFERENCE TO RELATED APPLICATION

This application claims the benefit of U.S. Provisional Application Ser. No. 60/678,345 filed May 6, 2005.

### FIELD OF INVENTION

This invention is related to multi-layer lap sealable thermoplastic films. These films exhibit improved handling characteristics.

### BACKGROUND OF INVENTION

Heat sealable plastic films are commonly used in the flexible packaging markets, particularly for the packaging of snacks and other dry goods. Accordingly, there are several commercially available schemes to produce heat-sealed packages.

The two common types of heat seal packaging films are fin seal films (face to face seal) and lap seal films (face to back seal). Heat sealing is usually accomplished in a commercial process via the use of mechanical heated jaws. The amount of time the heat sealing films are kept between the jaws and the temperatures required to achieve the desired heat seal properties are all inversely proportional to their commercial utility. Consequently, it is desirable to increase the speed at which a heat sealing process can be accomplished to insure that more packages can be commercially produced per minute.

The commercial production of a fin sealable polyethyleneterephthalate film (PET) substrate is typically accomplished through the use of a two layer co-extrusion process. Such a process is mentioned in No. U.S. Pat. No. 4,375,494. However, the production of a three layer heat sealable film according to such a process has many commercial restrictions. For instance, the low crystallinity of heat sealable resins make them prone to blocking when wound upon themselves.

Other common difficulties occur in the processing of two sided sealable PET films. Two sided heat sealable films are useful because of their ability to form lap seals, which are an efficient and esthetically pleasing method of producing sealed structures.

The most common method of orienting, or stretching, PET based films is with the use of a heated roller assembly coupled to a chain driven transverse stretching frame. An example of such a process is described in U.S. Pat. No. 4,375,494. As one can readily imagine, the use of heated rollers to stretch, or draw the film, implies that the film is in contact with a heated surface under pressure. Heat and pressure are used to seal a lap sealable packaging structure. Therefore, there is an inherent tendency for two-sided sealable, low crystallinity, PET films to stick or adhere to the roller train used to stretch the films. This makes it difficult to prepare two-sided heat sealable PET films on a commercial basis.

Another problem with typical lap sealable films occurs because the formation of lap seals requires the application of pressure from the heated steel jaws of packaging machines against a heat sealable side of the film. Packaging machines are designed for high-speed forming, filling and sealing. Thus it is typically important that the films do not excessively stick to the jaws and jam the flow of the product and packaging. However, due to the greater polarity of polyester sealants, and their affinity for polar substrates such as steel and aluminum, hot polyester sealants will stick to bare metal more easily than to polyolefin. Accordingly, it is difficult to prepare lap heat sealable films that do not stick to the heat seal jaws or leave a residue buildup on the sealing jaws. A small amount of heat sealant residue can stick to the jaws even though the package may not stick. The residue can build-up with time and cause undesirable debris in the packaging area or eventually lead to package sticking.

Typically, to avoid these problems release tape is frequently applied to the jaws or the jaws are frequently cleaned. In addition, replacement jaws are coated with a release layer consisting of a non-polar polymer such as poly(tetrachloroethylene). While the release layer resists the adhesion of sealant polymers, this has to be made thin to minimize thermal conductivity losses. Consequently, this layer can be easily scratched or damaged during use or during jaw cleaning. It is not practical to frequently replace the heat seal jaws with fresh release coatings or release tape.

### SUMMARY OF THE INVENTION

The disclosed films and methods seek to avoid some of the disadvantages of typical lap sealable films. By controlling the composition and thickness of the surface layers of the lap sealable films, the disclosed films possesses the good properties of monolayer high crystalline polyester films, such as low haze, high strength, high thermal dimensional stability and good handling properties.

One embodiment is a film including a core layer that includes a polyester with a crystallinity value greater than 35%. The film also includes a first lap sealable layer on a first surface of the core layer including a polyester with a crystallinity value less than 35% and substantially spherical particles, and a second lap sealable layer on a second surface of the core layer including a polyester with a crystallinity value less than 35% and substantially spherical particles.

Preferably, the first and second lap sealable layers each have a thickness of 0.3 μm to 1.0 μm and the thickness ratios of the of the first and second lap sealable layers to the core layers are about 1 to 6 to about 1 to 25.

Preferably, the substantially spherical particles have an aspect ratio of less than 5. Preferred substantially spherical particles are silica particles. Preferably, the ratio of the mean spherical particle size of the substantially spherical particles to the thickness of the lap sealable film layer in which they are disposed is 4 to 1 to 2 to 1. Preferably, the substantially spherical particles have a mean particle size of 1 to 6 micrometers. Preferably, the first and second lap sealable layers comprise 0.2 wt. % to 0.5 wt. % substantially spherical particles.

Preferably, the total thickness of the core layer and the first and second lap sealable layers is 5 μm to 60 μm. Preferably, the film has a static coefficient of friction to itself of less than 0.4. Preferably, the film has a haze % of 1% to 8%.

Another embodiment is a method of producing a film. The method includes co-extruding a core layer including a polyester with a crystallinity value greater than 35%, a first lap sealable layer on a first surface of the core layer including a polyester with a crystallinity value less than 35% and substantially spherical particles, and a second lap sealable layer on a second surface of the core layer including a polyester with a crystallinity value less than 35% and substantially spherical particles. Preferably, the method also includes biaxially stretching the film, and heat setting the stretched film.

### DETAILED DESCRIPTION OF THE INVENTION

Disclosed are lap sealable PET films and methods of producing such films. The films utilize specific filler particles and surface layer thicknesses to overcome and alleviate previous detrimental problems related to the use of non-crystalline or low-crystalline resins that are used to produce heat sealable PET films.

The films preferably include three layers: a core layer, a first lap sealable polyester layer that includes substantially spherical particles and a second lap sealable polyester layer that includes substantially spherical particles. The core layer does not need to include these substantially spherical particles. The lap sealable film layers are adhered to both surfaces of the core layer.

The core layer preferable includes a highly crystalline polyester, such as a high crystallinity homo-polymer or low co-monomer content polymer, for example poly(ethyleneteraphthalate), with low co-monomer content and having an equilibrium melting point of greater than 245° C.

Crystallinity is defined as the weight fraction of material producing a crystalline exotherm when measured using a differential scanning calorimeter. For a highly crystalline polyester, an exothermic peak in the melt range of 220° C. to 290° C. is most often observed. High crystalllinity is therefore defined as the ratio of the heat capacity of material melting in the range of 220° C. to 290° C. versus the total potential heat capacity for the entire material present if it were all to melt. A crystallinity value of >35% weight fraction is considered high crystallinity.

A variety of non-crystalline or low crystalline polyester resins may be used in the sealable film layers. The low crystallinity polyesters have a crystallinity value of <35%. Preferred polyester resins include non-crystalline or low crystalline polyesters based upon isophthalic acid residues, cyclohexanedimethanol residues or blends of different polyester compositions whose blends have sufficiently slow crystallization rates to render the blend low crystalline, a combination of isophthalic acid and cyclohexanedimethanol residues, or any combination of dicarboxylic acids and aliphatic diols having a glass transition temperature greater than 50° C. A more preferred polyester resin is an isophthalic acid modified polyester resin.

The thickness of the heat sealable layers is related to the heat seal strength of the film. If the layers are too thin, sufficient heat seal strength may not be obtained. If the layers are too thick, the film may become overly tacky.

Preferably, the first and second lap sealable film layers each have a thickness of about 0.3 μm to about 1.0 μm, more preferably about 0.4 μm to about 0.8 μm, most preferably 0.5 μm to about 0.7 μm. Preferably, the thickness ratios of the first and second lap sealable film layers to the core layer each are about 1 to 6 to about 1 to 25.

The lap sealable film layers preferably include substantially spherical particles. The addition of these particles has been found to limit blocking during winding of the film. By substantially spherical, it is meant that the particles do not have a platelet nature and do not have the high aspect ratios typical of platelet particles such as talc, clay, nanotubes, and fibers etc., which typically have aspect ratios of 10 to 20. More preferably, the substantially spherical particles have an aspect ratio less than 5.

Preferred substantially spherical particles are silica particles. Preferred particles with an aspect ratio of less than 5 can be obtained by re-dispersion of lightly agglomerated silica powder by melt blending with polyester in a twin screw extruder. The silica powder can be obtained by neutralizing solutions of sodium silicate to form primary sub-micron silica particles that are chemically associated and bonded to each other forming a secondary structure. The secondary structure can be mechanically ground to form smaller secondary structures having an average effective spherical diameter of 2-3 μm and composed of strongly bonded sub-micron primary spherical silica particles. The effective average diameter of the secondary structured particle can be obtained from dynamic laser light scattering, where the equivalent spherical diameter is obtained from the diffusion effect on light scattering. The ratio of the mean spherical particle size to the thickness of the lap sealable film layer in which they are disposed is preferably about 4 to 1 to about 2 to 1. More preferably the particles have a mean particle size of from 1 to 6 μm, even more preferably from 1.5 to about 4 μm, and most preferably from 2 to 3 μm.

Preferably, the lap sealable film layers are extruded separately, joined in their molten state to the core layer in a feedblock, shaped into a flat melt film simultaneously in a die, and cast onto a take-off chill roll, creating a three layer structure.

Preferably, the particle loading amount of the spherical particles in the lap sealable layer is about 0.2 wt. % to about 5 wt. %, more preferably about 0.3 wt. % to about 2 wt. % based upon the total weight of the lap sealable layer and the spherical particles.

The three layer film structure, which includes a core layer and first and second lap sealable film layers disposed on opposite sides of the core layer, preferably has a total thickness of about 5 μm to about 60 μm, more preferably 10 μm to about 50 μm, most preferably about 10 μm to about 25 μm.

Preferably, the static coefficient of friction of the film to itself measured according to ASTM 8.01 D1894 is less than 0.65, more preferably less than 0.50, and even more preferably less than about 0.40. Preferred ranges for the static coefficient of friction are 0.25 to 0.65, more preferably, 0.28 to about 0.50, and even more preferably about 0.3 to about 0.4.

The final film preferably possesses low haze properties that are representative of monolayer high crystalline polyester films. Preferably, the haze % is about 1 to 8%, more preferably, 2 to about 7%, and even more preferably 3 to about 6%.

The final film may be made by conventional means, where three molten streams, from at least 2 extruders, are brought together in a die or feedblock and cast into a thick sheet on a cooling drum and then continuously stretched either sequentially in the machine direction (MD) followed by the transverse direction (TD) or simultaneously in the MD and TD to give a final film thickness of about one-sixteenth the cast sheet thickness. In addition the film can be post tensilized.

This invention will be better understood with reference to the following non-limiting examples, which are intended to illustrate specific embodiments within the overall scope of the invention.

### EXAMPLES

The examples were prepared on a commercial film production line at a high line speed. Films that included a two layer construction and a three layer construction were produced. The two layer films included only a single sealable layer. In the case of a three layer construction, the films were tested by sealing face to back in the desired lap seal configuration, as well as testing the coefficient of friction (COF). For the two layer constructions, the films were tested for both COF and heat seals in a face to face configuration. The face to face mode was used for testing purposes. Data modeled on a two layer sample was found to translate to a three layer target construction with good correlation.

### Core Layer Preparation

The middle or “core” crystalline PET layers were prepared according to the following process:

Polyester A. Polyethylene terephthalate was polymerized in the following manner. A melt slurry of ethylene glycol and purified terephthalic acid was heated in the presence of an esterification catalyst of trimethylphosphate of about 0.032 wt. %, magnesium acetate of about 0.060 wt. %, antimony trioxide of about 0.026 wt. %, and tetraethyl ammonium hydroxide of about 0.252 wt. %. The water and excess ethylene glycol were removed under vacuum leaving a residual melt Polyester A. This melt was discharged via a strand die into a cooling trough, pelletized, and then further dried to remove residual moisture to less than about 50 parts per million. External particles were not added to Polyester A.

Polyester B. Polyethylene terephthalate was polymerized in the following manner. A melt slurry of ethylene glycol and purified terephthalic acid was heated, in the presence of an esterification catalyst of lithium acetate dihydrate of about 0.226 wt. %, trimethylphosphate of about 0.181 wt. %, phosphorous acid of about 0.020 wt. %, antimony trioxide of about 0.04 wt. %, and calcium acetate of about 0.119 wt. %. The water and excess ethylene glycol were removed under vacuum leaving a residual melt as Polyester B. This melt was discharged via a strand die into a cooling trough, pelletized, and then further dried to decrease the residual moisture down to less than about 50 parts per million resin.

Polyester C. SiO₂ particles (Particles A) of a volume average particle diameter of about 2.6 μm were admixed into a slurry of ethylene glycol and purified terephthalic acid. The slurry was polymerized by a regular method as is known in the art using tetraethyl ammonium hydroxide of about 0.049 wt. %, lithium acetate dihydrate of about 0.882 wt. %, antimony trioxide of about 0.039 wt. %, calcium acetate of about 0.090 wt. %, and trimethylphosphate of about 0.042 wt. %. The melt slurry was heated, in the presence of an esterification catalyst, and the water and excess ethylene glycol were removed under vacuum leaving a residual melt of Polyester C. The content of Particles A in the Polyester Pellet C was about 2.0 wt. % based upon the total weight of polyester and silica particles. This melt was discharged via a strand die into a cooling trough, pelletized, and then further dried to decrease the residual moisture down to less than about 50 parts per million resin.

Homopolymer Core Layer. Next, 48.5 parts by weight of pellets (Polyester A), 48.5 parts by weight of pellets (Polyester B), and 3.0 parts by weight of pellets (Polyester C), were mixed. Up to about 30% recycle consisting of finished film can replace equal parts of polymer A and polymer B. The mixed pellets were dried under vacuum at about 150° C. for about 3 hours and supplied to an extruder, melted, mixed and extruded at a temperature of 285° C., to produce a melt stream (II).

### Surface Layer Preparation (Co-Extrusion Process)

Melt stream (I), the contents of which are described below in the specific Examples, includes a noncrystalline or low crystalline polyester and forms the sealant layer or layers. Melt stream (I) was fed through a rectangular joining zone where it was laminated to a melt stream of polyester (II). The laminate melt is shaped into a flat melt film to produce a three layer co-extruded I/II/I structure, where melt stream (I) and melt stream (II) are not the same. The resulting melt structure exits the die lip as a melt curtain that is quenched on a moving casting drum, and then biaxially oriented via subsequent heated stretching steps on a roller train and chain driven transverse stretcher. Finally, the biaxially stretched film is subjected to a heat-setting step, where the film is kept at a temperature of approximately 180° C. to 250° C. for a period of about 1 to 4 seconds, before cooling and winding a customary roll. The total thickness of the film ranges from about 4.5 μm to about 60 μm.

The copolyester referred to in the examples is a commercially available isophthalic acid modified PET. This material is a 19 wt. % substitution of isophthalic acid for terephthalic acid modified copolyethyleneterephthalate resin. This material was filled with particles as described below through a dry compounding process. In this methodology, the filler was added via a powder feed system into a molten stream of copolyester via the use of a twin screw extruder.

It is preferred to dry the copolyester resin through the use of a vent box type extruder. In the compounding process, the filled molten resin stream is evacuated through a gas discharge port on the barrel of the twin screw extruder. By utilizing this process the molecular weight of the copolyester can be maintained within a desired value such that the change in molecular weight average of the layer in the film is negligible. To insure good layer distribution in a coextrusion process it is preferred to maintain similar viscosities between the different layers.

### Testing and Measurement Methods

Particle size as described herein is measured by a slurry type light scattering process. Such a process is well known in the art, and involves measuring the particle size of a dispersion of the particles before incorporation into the polyester. The measurement is made from laser light scattering from a dilute water dispersion of the particles. The water dispersion is made by adding dry powder to water which contains a small amount of surfactant, followed by sonic power agitation.

The thickness of the co-extrusion layer can be calculated through material outputs. Alternatively the thickness can be measured via a solvent removal process of the non-crystalline layer. A third method involves measuring layer thickness via the use of a white light interferometer. Comparisons of these methods have shown good correlation. Therefore, the thickness numbers reported in the examples can refer to any or all measurement techniques.

Heat seal strengths were measured by either one of two methods. For the two layer film construction, a two layer sample was prepared wherein the co-extruded copolyester materials were brought together in a face-to-face configuration. This film was then transported to a Sentinel heat seal apparatus. This instrument uses a pair of jaws, one flat steel heated bar of 1″ depth and one unheated rubber bar covered with release coated fabric. The jaws are brought into contact with the film for a specified period of time and under a specified pressure, to form the heat seal.

The heat sealable film was then cut into 1″ strips perpendicular to the sealed area and the strength of the 1″ heat sealed area was measured as the peel force via the use of a load cell and a constant rate of grip separation of 12 inches per minute. The sealed area of the film strips was held by hand loosely to maintain a constant peel angle of 90 degrees between the separated strips and the unseparated area. The peel force reported in the tables is the maximum measured force per unit width for seal conditions of about 284° F., at 30 pounds per square inch (PSI) jaw pressure and a dwell time of 0.5 seconds.

For the three layer film construction, two sheets of three layer film were positioned so as the co-extruded face materials were brought together in a face-to-back configuration. These film combinations were then transported to a Sentinel heat seal apparatus and heat sealed as described above.

The heat sealed films were then cut into a 1″ strip and the strength of the delamination or peel force to separate was measured exactly as described above. Data is reported in grams per millimeter (mm).

### Example 1(92 Gage (G))

A three layer sample was produced on the commercial film producing line using for the surface sealant layers a 19 wt. % isophthalic acid modified copoly(ethyleneterephthalate), containing a melt compounded 2.8 μm silica at about 0.4 wt. % loading of the silica. The sealant layer thickness was set at about 0.6 μm and was confirmed via thickness measuring techniques. The core layer was produced as described above. The total film thickness was targeted at 92 G (23.4 μm) including the surface layer thickness component. This example was found to have low haze, good sealing characteristics and desired coefficient of friction (COF) or handling properties. The properties of this film are summarized in Table 1.

### Example 2 (48 G)

A three layer sample was produced on the commercial film production line using for the sealant layers the same 19 wt. % isophthalic acid modified polyester resin as described in Example 1. The sealant layers also contained a melt compounded 2.8 μm silica, but the silica loading was at about 0.3 wt. % loading. The core layer was the same as in Example 1. The surface layer thickness was set to about 0.6 μm and was confirmed via thickness measuring techniques. In this example, the total thickness of the film was targeted to 48 G (12.2 μm) including the surface layer components. This example was found to have low haze, good sealing characteristics and the desired COF or handling properties. The properties of this film are summarized in Table 1.

### Comparative Example 3 (92 G)

This two layer sample of LUMIRROR™ film, Product Code PA25, commercially available from TORAY PLASTICS (AMERICA), INC., was produced on the same commercial line via co-extrusion of the same 19% isophthalic acid modified polyester resin for the sealant surface layer and the same core layer as in Example 1. The sealant layer thickness was set to about 2.0 μm and was confirmed via thickness measuring techniques. In this example, the total thickness of the film was targeted to 92 G (23.4 μm) including the sealant layer component. No filler resin was added to the sealant layer. This example was found to have low haze and good sealing characteristics but very poor COF or handling properties. This type of structure would not be commercially suitable for a three layer construction due to the very high COF properties and the reduction in processing feeds on a commercial packaging line. The properties of this film are summarized in Table 1.

### Comparative Example 4 (92 G)

This two layer sample was produced on a commercial film line using for the sealant layer the same 19 wt. % isophthalic acid modified polyester resin as used in Example 1. This layer also contained a melt compounded 2.8 μm silica, but the silica loading was at about 1.5 wt. % loading. The core layer was the same core layer as in Example 1. The sealant layer thickness was set to about 1.8 μm and was confirmed via thickness measuring techniques. In this example, the total thickness of the film was targeted to 92 G (23.4 μm) including the sealant layer component. This example was found to have low haze and good sealing characteristics but marginal COF or handling properties. The properties of this film are summarized in Table 1.

### Comparative Example 5 (92 G)

This two layer sample was produced on a commercial film production line using for the sealant layer the same 19 wt. % isophthalic acid modified polyester resin as Example 1. This layer also contained a melt compounded 2.8 μm silica, but the silica loading was at about 1.6 wt. % loading. The core layer was the same core layer as in Example 1. The sealant layer thickness was set to about 1.1 μm and was confirmed via thickness measuring techniques. In this example, the total thickness of film was targeted to 23.4 μm including the sealant layer component. This example was found to have high haze but good sealing characteristics and the desired COF or handling properties. The high haze was thought to be of poor commercial utility. The properties of this film are summarized in Table 1.

### Comparative Example 6 (92 G)

This two layer sample was produced on a commercial film production line using for the sealant layer the same 19 wt. % isophthalic acid modified polyester resin as Example 1. This layer also contained a melt compounded 2.8 μm silica, but the silica loading was at about 1.6 wt. % loading. The core layer was the same core layer as in Example 1. The sealant layer thickness was set to about 0.4 μm and was confirmed via thickness measuring techniques. In this example, the total thickness of film was targeted to 23.4 μm including the sealant layer component. This example was found to have high haze and very poor sealing characteristics but the desired COF or handling properties. The poor haze and poor sealing characteristics make this sample of no commercial value for lap-sealing applications. The properties of this film are summarized in Table 1.

As shown in Table 1, the examples and comparative examples show that a lap sealable film that possesses the good properties of monolayer high crystalline polyester films, such as low haze, high strength, high thermal dimensional stability and good handling properties can be produced provided that the surface layer composition and thickness are controlled in the manner described here.

TABLE 1

| | | Silica % | | | Thickness | | | Static | |
|---|---|---|---|---|---|---|---|---|---|
| | | by | | | of | Overall | | Coefficient | |
| | | weight | Particle Size | | surface | Thickness | | of Friction | |
| | | in thin | by Weight | | sealant | of film | Heat seal | of thin | |
| Example | Film | surface | | Upper | layer(s) | composite | strength* | surface | Haze |
| Gage (G) | Structure | layer(s) | Median | Decile | (μm) | (μm) | (g/mm) | layer** | %*** |
| Example 1 | 3 layer | 0.42 | 2.8 | 3.9 | 0.63 | 23 | 4.76 | 0.33 | 6.1 |
| 92 G | | | | | | | | | |
| Example 2 | 3 layer | 0.28 | 2.8 | 3.9 | 0.61 | 12 | 7.14 | 0.36 | 3.3 |
| 48 G | | | | | | | | | |
| Comparative | 2 layer | None | None | None | 1.94 | 23 | 21.18 | n/a | 4.2 |
| Example 3 | | | | | | | | | |
| 92 G | | | | | | | | | |
| Comparative | 2 layer | 1.56 | 2.8 | 3.9 | 1.8 | 23 | 14.1 | 0.36 | 4 |
| Example 4 | | | | | | | | | |
| 92 G | | | | | | | | | |
| Comparative | 2 layer | 1.56 | 2.8 | 3.9 | 1.1 | 23 | 7.68 | 0.3 | 6.6 |
| Example 5 | | | | | | | | | |
| 92 G | | | | | | | | | |
| Comparative | 2 layer | 1.56 | 2.8 | 3.9 | 0.38 | 23 | none | 0.31 | 8.5 |
| Example 6 | | | | | | | | | |
| 92 G | | | | | | | | | |

*Heat seal conditions are sealable surface to sealable surface. For three layer films, the A/A, A/B and B/B heat-seal values are the same.
**Measured by ASTM 8.01 D1894. N/A values for friction indicate that the value was unobtainable due to the force of friction being larger than the force applied using the method.
***Haze measured by ASTM 8.01 D1003 incorporated herein in its entirety by reference.

This application discloses several numerical ranges in the text and figures. The numerical ranges disclosed are intended to support any range or value within the disclosed numerical ranges even though a precise range limitation is not stated verbatim in the specification because this invention can be practiced throughout the disclosed numerical ranges. It is also to be understood that all numerical values and ranges set forth in this application are necessarily approximate.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

1. A film comprising:
a core layer comprising a polyester with a crystallinity value greater than 35%,
a first lap sealable layer on a first surface of the core layer comprising a polyester with a crystallinity value less than 35% and substantially spherical particles, and
a second lap sealable layer on a second surface of the core layer comprising a polyester with a crystallinity value less than 35% and substantially spherical particles.

2. The film of claim 1, wherein the first and second lap sealable layers each have a thickness of 0.3 μm to 1.0 μm.

3. The film of claim 1, wherein the thickness ratios of the of the first and second lap sealable layers to the core layers are about 1 to 6 to about 1 to 25.

4. The film of claim 1, wherein the substantially spherical particles have an aspect ratio of less than 5.

5. The film of claim 1, wherein the substantially spherical particles are silica particles.

6. The film of claim 1, wherein the ratio of the mean spherical particle size of the substantially spherical particles to the thickness of the lap sealable film layer in which they are disposed is 4 to 1 to 2 to 1.

7. The film of claim 1, wherein the substantially spherical particles have a mean particle size of 1 to 6 micrometers.

8. The film of claim 1, wherein the first and second lap sealable layers comprise 0.2 wt. % to 0.5 wt. % substantially spherical particles.

9. The film of claim 1, wherein the total thickness of the core layer and the first and second lap sealable layers is 5 μm to 60 μm.

10. The film of claim 1, wherein the film has a static coefficient of friction to itself of less than 0.4.

11. The film of claim 1, wherein the film has a haze % of 1% to 8%.

12. A method for producing a film comprising:
co-extruding a core layer comprising a polyester with a crystallinity value greater than 35%, a first lap sealable layer on a first surface of the core layer comprising a polyester with a crystallinity value less than 35% and substantially spherical particles, and a second lap sealable layer on a second surface of the core layer comprising a polyester with a crystallinity value less than 35% and substantially spherical particles.

13. The method of claim 12, further comprising biaxially stretching the film.

14. The method of claim 13, further comprising heat setting the stretched film.

15. The method of claim 12, wherein the first and second lap sealable layers each have a thickness of 0.3 μm to 1.0 μm.

16. The method of claim 12, wherein the thickness ratios of the of the first and second lap sealable layers to the core layers are about 1 to 6 to about 1 to 25.

17. The method of claim 12, wherein the substantially spherical particles have an aspect ratio of less than 5.

18. The method of claim 12, wherein the substantially spherical particles are silica particles.

19. The method of claim 12, wherein the ratio of the mean spherical particle size of the substantially spherical particles to the thickness of the lap sealable film layer in which they are disposed is 4 to 1 to 2 to 1.

20. The method of claim 12, wherein the substantially spherical particles have a mean particle size of 1 to 6 micrometers.

21. The method of claim 12, wherein the first and second lap sealable layers each comprise 0.2 wt. % to 0.5 wt. % substantially spherical particles.

22. The method of claim 12, wherein the total thickness of the core layer and the first and second lap sealable layers is 5 μm to 60 μm.

23. The method of claim 12, wherein the film has a static coefficient of friction to itself of less than 0.4.

24. The method of claim 12, wherein the film has a haze % of 1% to 8%.
